(19) United States
(12) Patent Application Publication
(10) Pub. No.: US 2015/0193051 A1
(43) Pub. Date: Jul. 9, 2015

(54) TOUCH SYSTEM AND TOUCH-DETECTING METHOD THEREOF

(71) Applicant: Acer Incorporated, New Taipei City (TW)

(72) Inventor: Lun-Yu HUNG, New Taipei City (TW)

(21) Appl. No.: 14/578,769

(22) Filed: Dec. 22, 2014

(30) Foreign Application Priority Data
Jan. 8, 2014 (TW) 103100613

(51) Int. Cl. G06F 3/044

(52) U.S. Cl. CPC G06F 3/044

(57) ABSTRACT

The present disclosure provides a touch system including a touch interface, a touch module and a calculation unit. The touch module is arranged to detect a plurality of touch events on the touch interface, and accordingly produce a plurality of sensing signals, wherein the touch events are triggered by a plurality of touch objects with different electrical conductivities, and the sensing signals corresponding to the different touch objects have different voltages. The calculation unit is arranged to determine which of the touch objects the touch event is triggered by according to the voltages of the sensing signals produced by the touch module.

### CROSS REFERENCE TO RELATED APPLICATIONS

This Application claims priority of Taiwan Patent Application No. 103100613, filed on Jan. 8, 2014, the entirety of which is incorporated by reference herein.

### BACKGROUND OF THE DISCLOSURE

1. Field of the Disclosure

The present disclosure is related to a touch-detecting method of a touch system, and in particular to a touch-detecting method capable of determining the touch object according to the electronic conductivity of the touch object.

2. Description of the Related Art

Presently, mobile devices are highly developed and multi-functional. For example, handheld devices such as mobile phones and tablets are capable of conducting telecommunications, receiving and transmitting e-mails, maintaining social networks, managing contacts, and playing media. Hence, users can implement various applications on their mobile devices, such as a simple phone call, social network interaction, or commercial transactions. Therefore, mobile devices have become one of the necessities in people's lives.

Many electronic devices are equipped with touch panels, such that users may input data through the panel. The touch signal is related to the gestures. Therefore, the determination of the gesture becomes a noteworthy topic.

### BRIEF SUMMARY OF THE DISCLOSURE

A detailed description is given in the following embodiments with reference to the accompanying drawings.

The present disclosure provides a touch system including a touch interface, a touch module and a calculation unit. The touch module is arranged to detect a plurality of touch events on the touch interface, and accordingly produce a plurality of sensing signals, wherein the touch events are triggered by a plurality of touch objects with different electrical conductivities, and the sensing signals corresponding to the different touch objects have different voltages. The calculation unit is arranged to determine which of the touch objects the touch event is triggered by according to the voltages of the sensing signals produced by the touch module.

The present disclosure further provides a touch-detecting method applied to a touch system. The touch-detecting method includes: detecting a plurality of touch events on the touch interface and accordingly producing a plurality of sensing signals by a touch module, wherein the touch events are triggered by a plurality of touch objects with different electrical conductivities, and the sensing signals corresponding to the different touch objects have different voltages; and determining which of the touch objects the touch event is triggered by according to the voltages of the sensing signals by a calculation unit.

### BRIEF DESCRIPTION OF THE DRAWINGS

The present disclosure can be more fully understood by reading the subsequent detailed description and examples with references made to the accompanying drawings, wherein:

FIG. 1 is a schematic diagram illustrating an embodiment of a touch system of the present disclosure;

FIG. 2 is a schematic diagram illustrating another embodiment of a touch electronic device of the present disclosure;

FIG. 3 is a schematic diagram illustrating another embodiment of the touch electronic device of the present disclosure;

FIG. 4 is a flowchart of touch-detecting method according to an embodiment of the present disclosure;

FIG. 5 is a flowchart of touch-detecting method according to another embodiment of the present disclosure.

### DETAILED DESCRIPTION OF THE DISCLOSURE

The following description is of the best-contemplated mode of carrying out the disclosure. This description is made for the purpose of illustrating the general principles of the disclosure and should not be taken in a limiting sense. The scope of the disclosure is best determined by reference to the appended claims.

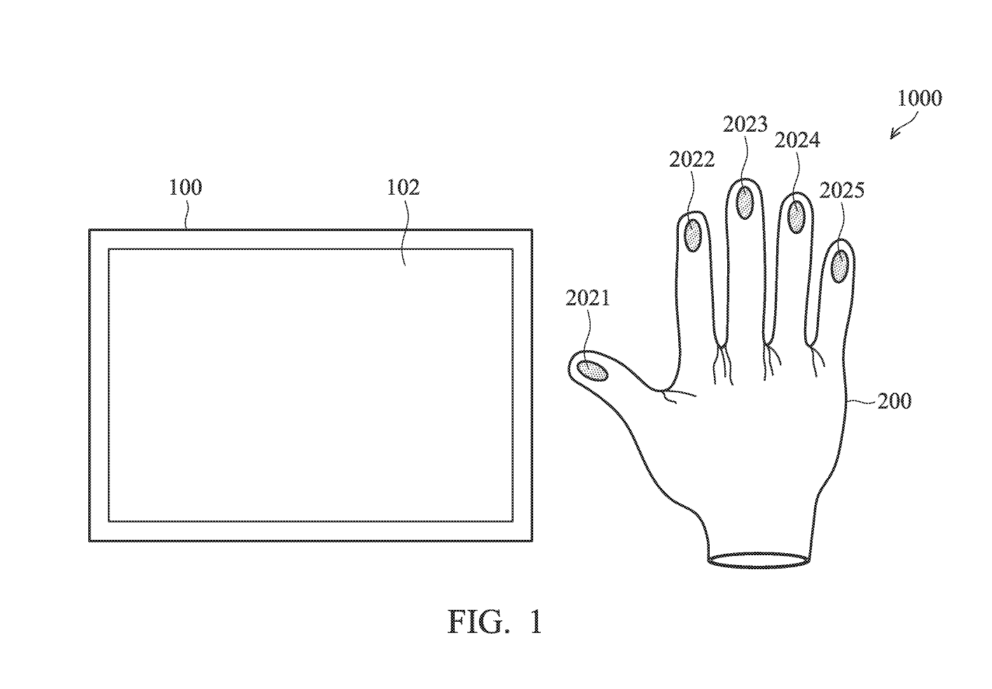

FIG. 1 is a schematic diagram illustrating an embodiment of a touch system of the present disclosure. The touch system 1000 includes a touch electronic device 100 and a touch glove 200. The touch electronic device 100 has a touch interface 102. The touch glove 200 has a plurality of touch objects 2021-2025 implemented on different fingers of the touch glove, and the touch objects 2021-2025 come in contact with the touch interface 102 which triggers the touch events, wherein the touch objects 2021-2025 may consist of materials with different electrical conductivities, such that the touch objects 2021-2025 may trigger the different touch events with different electrical conductivities on the touch interface 102. For example, the touch objects 2021-2025 may consist of silver, copper, gold, aluminum and other metallic materials, wherein the electrical conductivity of silver is 63.01×106(S·m−1), the electrical conductivity of copper is 59.6×106(S·m−1), the electrical conductivity of gold is 45.2×106(S·m−1), the electrical conductivity of aluminum is 37.8×106(S·m−1), but it is not limited thereto. In one embodiment, the touch objects 2021-2025 may consist of metal threads with different electrical conductivities, and the metal threads may be woven in the position of each of the fingers of the touch glove 200, but it is not limited thereto. It should be noted that, in another embodiment, the touch glove 200 may only have three touch objects 2021-2023, and the three objects 2021-2023 are implemented on the positions of the thumb, the forefinger and the middle finger of the touch glove. In other embodiments, the touch glove 200 may only have two touch objects 2021-2022, and the two touch objects 2021-2022 are implemented on the positions of the thumb and the forefinger, but it is not limited thereto. It should be noted that the touch objects 2021-2022 may be implemented on other positions of the touch glove 200, such as the position of the palm and the fingertips, but it is not limited thereto.

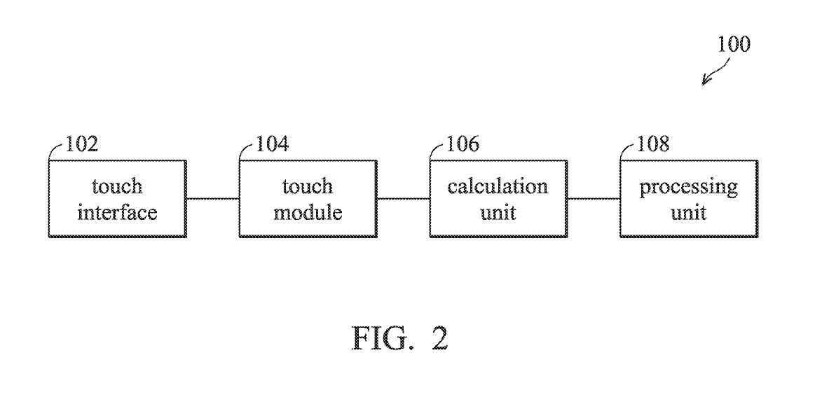

FIG. 2 is a schematic diagram illustrating another embodiment of a touch electronic device of the present disclosure. A person skilled in the art may also implement the touch electronic device 100 on a computer configuration with a touch interface, such as hand-held devices, portable devices, personal digital assistants, processing unit systems, microprocessor-based or programmable consumer electronics, etc. The touch electronic device 100 includes a touch interface 102, a touch module 104, a calculation unit 106 and a processing unit 108.

The touch interface 102 is arranged to detect the touch events triggered by the touch glove 200. In one embodiment, the touch interface 102 may also include a display unit (not shown) arranged to display images. The display unit may be liquid-crystal display or light-emitting diode, etc., but it is not limited thereto.

The touch module 104 is arranged to detect the touch events on the touch interface 102 and accordingly produce the corresponding sensing signals, wherein the touch events may be triggered by the touch objects 2021-2025 with different electrical conductivities, and the touch module 104 is arranged to produce the sensing signals with different voltage levels in response to the different intensities of capacitive sensing produced by the touch objects 2021-2025.

The calculation unit 106 may include a memory device, a central-processing unit and/or a central-processing unit or a plurality of parallel processing units related in a parallel processing environment. The memory device can include a read only memory (ROM), a flash ROM and/or a random access memory (RAM), arranged to store the programs executed by the calculation unit 106. It should be noted that the processing unit 108 may be arranged in the chip of the touch module 104 or in the other processors, but it is not limited thereto. The calculation unit 106 is arranged to determine which of the touch objects 2021-2025 triggers the touch event according to the voltage level of the sensing signal produced by the touch module 104 and to produce the determining signal corresponding to the touch object which triggered the touch event. For example, when the touch event is triggered by the touch objects 2021 which consists of silver material implemented on the thumb of the touch glove 200, the touch module 104 produces a first sensing signal in response to the sensing capacitance produced by the silver material. When the touch event is triggered by the touch object 2022 which consists of copper material implemented on the forefinger of the touch glove 200, the touch module 104 produces a second sensing signal in response to the sensing capacitance produced by the copper material. When the touch event is triggered by the touch object 2023 which consists of gold material implemented on the middle finger of the touch glove 200, the touch module 104 produces a third sensing signal in response to the sensing capacitance produced by the gold material, but it is not limited thereto. Silver, copper and gold have different electrical conductivities from each other, such that the first sensing signal, the second sensing signal and the third sensing signal have different voltage levels. Next, the calculation unit 106 can determine that the touch event is triggered by the touch object 2021 which consists of silver according to the voltage level of the first sensing signal, and accordingly produce a first determining signal. The calculation unit 106 can determine that the touch event is triggered by the touch object 2022 which consists of copper according to the voltage level of the second sensing signal, and accordingly produce a second determining signal. The calculation unit 106 can determine that the touch event is triggered by the touch object 2023 which consists of gold according to the voltage level of the third sensing signal, and accordingly produce a third determining signal, but it is not limited thereto.

The processing unit 108 may include a memory device, a central-processing unit and/or a plurality of parallel processing units related in a parallel processing environment. The memory device can include a read only memory (ROM), a flash ROM and/or a random access memory (RAM), arranged to store the programs used for executing by the processing unit 108. It should be noted that the processing unit 108 may be arranged in the chip of the touch module 104 or in the other processors, but it is not limited thereto. In this embodiment, the processing unit 108 is arranged to determine that the touch object which triggered the touch event is corresponding to which fingers according to the determining signal produced by the calculation unit 106. For example, the processing unit 108 can determine that the touch object 2021 which triggered the touch event is corresponding to the thumb of the user according to the first determining signal. The processing unit 108 can determine that the touch object 2022 which triggered the touch event is corresponding to the forefinger of the user according to the second determining signal. The processing unit 108 can determine that the touch object 2023 which triggered the touch event is corresponding to the middle finger of the user according to the third determining signal, but it is not limited thereto.

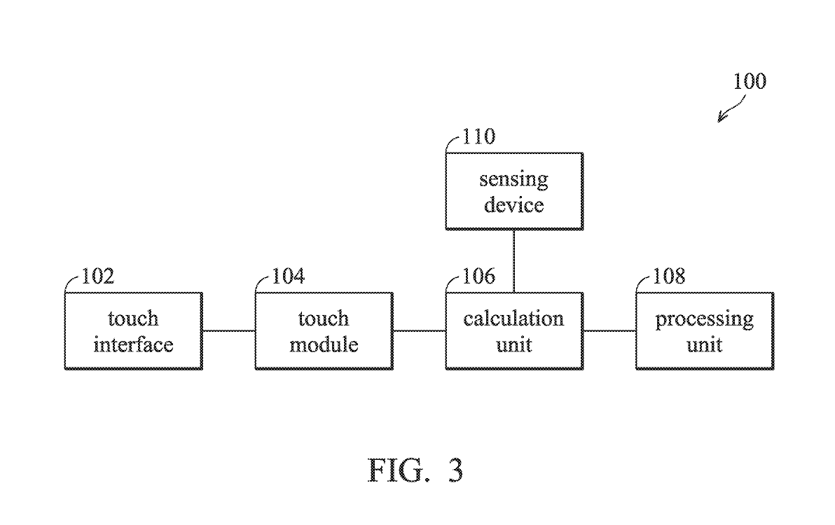

FIG. 3 is a schematic diagram illustrating another embodiment of the touch electronic device of the present disclosure. The touch electronic device 100 of FIG. 3 is similar to the touch electronic device 100 of FIG. 2, except that the touch electronic device 100 of FIG. 3 further includes a sensing device 110. The details of the touch interface 102, the touch module 104, the calculation unit 106 and the processing unit 108 can be referred to in FIG. 2.

The sensing device 110 is arranged to determine whether the touch objects 2021-2025 come in contact with the touch interface 102. When the touch objects 2021-2025 comes in contact with the touch interface 102, the sensing device 110 enable the calculation unit 106 to produce the determining signals. When none of the touch objects 2021-2025 comes in contact with the touch interface 102, the sensing device 110 disables the calculation unit 106 to produce the determining signals. Namely, in this embodiment, the calculation unit 106 is arranged to produce the determining signals corresponding to the sensing signals when the touch objects 2021-2025 comes in contact with the touch interface 102 according to the signals of the sensing device 110. When none of the touch objects 2021-2025 comes in contact with the touch interface 102, the calculation unit 106 ignores the sensing signals produced by the sensing device 110. In one embodiment, the sensing device 110 is an image determination device arranged to capture images of the touch interface 102 and determine whether the touch objects 2021-2025 comes in contact with the touch interface 102 according to the image of the touch interface 102. In another embodiment of the present invention, the sensing device 110 is a pressure sensing device 110 arranged to detect the pressure of the touch interface 102 and determine whether the touch objects 2021-2025 comes in contact with the touch interface 102 according to the pressure of the touch interface 102.

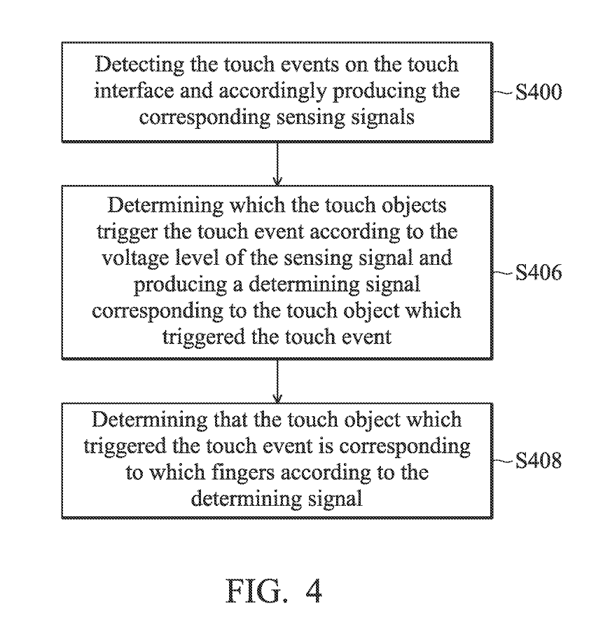

FIG. 4 is a flowchart of touch-detecting method according to an embodiment of the present disclosure. The touch-detecting method is applied to the touch system 1000 of FIG. 1. The process starts at step S400.

In step S400, the touch module 104 is arranged to detect the touch events on the touch interface 102 and accordingly produce the corresponding sensing signals, wherein the touch events may be triggered by the touch objects 2021-2025 with different electrical conductivities, and the touch module 104 is arranged to produce the sensing signals with different voltage levels in response to the different intensities of capacitance sensing produced by the touch objects 2021-2025. For example, when the touch event is triggered by the touch objects 2021 which consists of silver material implemented on the thumb of the touch glove 200, the touch module 104 produces a first sensing signal in response to the sensing capacitance produced by the silver material. When the touch event is triggered by the touch object 2022 which consists of copper material implemented on the forefinger of the touch glove 200, the touch module 104 produces a second sensing signal in response to the sensing capacitance produced by the copper material. When the touch event is triggered by the touch object 2023 which consists of gold material implemented on the middle finger of the touch glove 200, the touch module 104 produces a third sensing signal in response to the sensing capacitance produced by the gold material, but it is not limited thereto. Silver, copper and gold have different electrical conductivities from each other, such that the first sensing signal, the second sensing signal and the third sensing signal have different voltage levels. It should be noted that the touch module 104 may simultaneously detect a plurality of the touch events, and simultaneously produce a plurality of corresponding sensing signals.

Next, in step S406, the calculation unit 106 is arranged to determine which of the touch objects 2021-2025 triggers the touch event according to the voltage level of the sensing signal produced by the touch module 104 and produce a determining signal corresponding to the touch object which triggered the touch event. For example, the calculation unit 106 can determine that the touch event is triggered by the touch object 2021 which consists of silver according to the voltage level of the first sensing signal, and accordingly produce a first determining signal. The calculation unit 106 can determine that the touch event is triggered by the touch object 2022 which consists of copper according to the voltage level of the second sensing signal, and accordingly produce a second determining signal. The calculation unit 106 can determine that the touch event is triggered by the touch object 2023 which consists of gold according to the voltage level of the third sensing signal, and accordingly produce a third determining signal, but it is not limited thereto.

Next, in step S408, the processing unit 108 is arranged to determine that the touch object which triggered the touch event corresponds to which fingers according to the determining signal produced by the calculation unit 106. For example, the processing unit 108 can determine that the touch object 2021 which triggered the touch event is corresponding to the thumb of the user according to the first determining signal. The processing unit 108 can determine that the touch object 2022 which triggered the touch event is corresponding to the forefinger of the user according to the second determining signal. The processing unit 108 can determine that the touch object 2023 which triggered the touch event is corresponding to the middle finger of the user according to the third determining signal, but it is not limited thereto. The process ends at step S408.

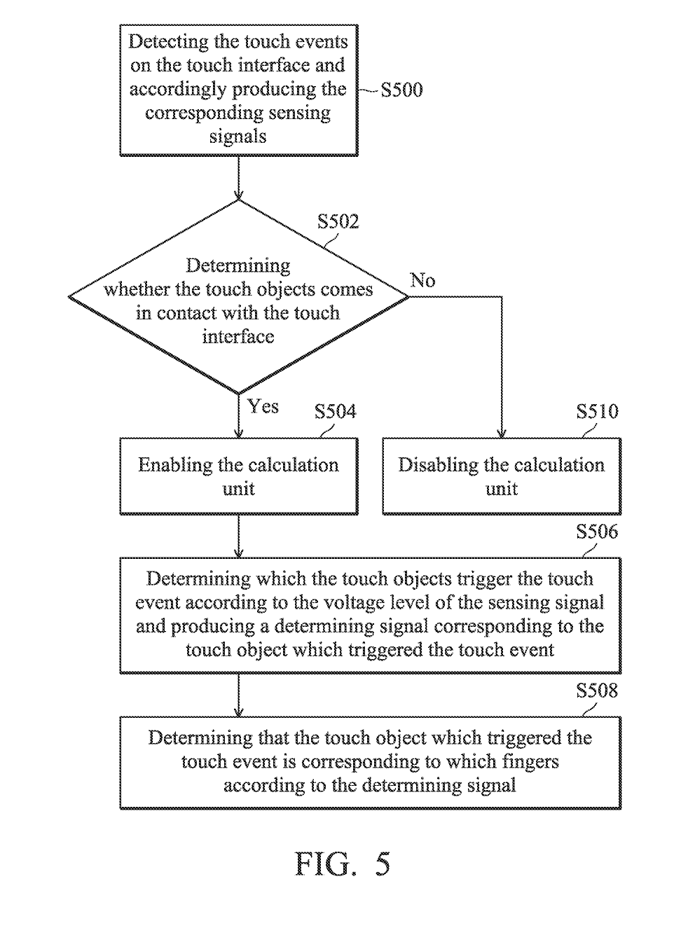

FIG. 5 is a flowchart of touch-detecting method according to another embodiment of the present disclosure. The touch-detecting method is applied to the touch system 1000 of FIG. 1. The process starts at step S500. It should be noted that steps S500, S506 and S508 are similar to steps S400, S406 and S408. The details of steps S500, S506 and S508 may be referred to in FIG. 4.

In step S502, the sensing device 110 is arranged to determine whether the touch objects 2021-2025 comes in contact with the touch interface 102. When the touch objects 2021-2025 come in contact with the touch interface 102, the process goes to step S504. When none of the touch objects 2021-2025 comes in contact with the touch interface 102, the process goes to step S510.

In step S504, the sensing device 110 enables the calculation unit 106.

In step S510, the sensing device 110 disables the calculation unit 106. The process ends at step S510. Namely, in this embodiment, the calculation unit 106 is arranged to produce the determining signals corresponding to the sensing signals when the touch objects 2021-2025 comes in contact with the touch interface 102 according to the signals of the sensing device 110. When none of the touch objects 2021-2025 comes in contact with the touch interface 102, the calculation unit 106 ignores the sensing signals produced by the sensing device 110. In one embodiment, the sensing device 110 is an image determination device arranged to capture images of the touch interface 102 and determine whether the touch objects 2021-2025 comes in contact with the touch interface 102 according to the image of the touch interface 102. In another embodiment of the present invention, the sensing device 110 is a pressure sensing device 110 arranged to detect the pressure of the touch interface 102 and determine whether the touch objects 2021-2025 comes in contact with the touch interface 102 according to the pressure of the touch interface 102.

The touch system 1000 and the touch-detecting method of the present invention may determine which fingers touch the touch interface 102 by the metals with different electrical conductivities of the touch glove 200.

Data transmission methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

While the disclosure has been described by way of example and in terms of the preferred embodiments, it is to be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch system, comprising:
a touch interface;
a touch module, arranged to detect a plurality of touch events on the touch interface, and accordingly produce a plurality of sensing signals, wherein the touch events are triggered by a plurality of touch objects with different electrical conductivities, and the sensing signals corresponding to the different touch objects have different voltages; and
a calculation unit, arranged to determine which of the touch objects the touch event is triggered by according to the voltages of the sensing signals produced by the touch module.

2. The touch system as claimed in claim 1, further comprising a sensing device arranged to determine whether the touch objects touch the touch interface, wherein the sensing device enables the calculation unit to produce a determining signal when one of the touch objects touch the touch interface, and the sensing device disables the calculation unit to produce the determining signal when none of the touch objects touch the touch interface.

3. The touch system as claimed in claim 2, wherein the sensing device is an image determination device arranged to capture images of the touch interface and determine whether at least one of the touch objects comes in contact with the touch interface according to the captured images.

4. The touch system as claimed in claim 2, wherein the sensing device is a pressure sensing device arranged to detect the pressure of the touch interface and determine whether the touch objects comes in contact with the touch interface according to the pressure of the touch interface.

5. The touch system as claimed in claim 1, further comprising a touch glove having at least two of the touch objects, wherein the touch objects are implemented on different positions of the touch glove.

6. The touch system as claimed in claim 5, wherein the touch objects are arranged to be implemented on the positions of the thumb, forefinger and middle finger of the touch glove.

7. The touch system as claimed in claim 6, wherein the calculation unit is further arranged to produce a determining signal according to the touch objects corresponding to the touch events, and the touch system further comprises a processing unit arranged to determine which finger corresponds to the touch events according to the determining signal.

8. A touch-detecting method, applied to a touch system, wherein the touch-detecting method further comprises:
detecting a plurality of touch events on the touch interface and accordingly producing a plurality of sensing signals by a touch module, wherein the touch events are triggered by a plurality of touch objects with different electrical conductivities, and the sensing signals corresponding to the different touch objects have different voltages; and
determining which of the touch objects the touch event is triggered by according to the voltages of the sensing signals by a calculation unit.

9. The touch-detecting method as claimed in claim 8, further comprising:
determining whether the touch objects touch the touch interface by a sensing device;
enabling the calculation unit to produce at least one determining signal by the sensing device when at least one of the touch objects touches the touch interface; and
disabling the calculation unit to produce the determining signal by the sensing device when none of the touch objects touches the touch interface.

10. The touch-detecting method as claimed in claim 9, wherein the sensing device is an image determination device arranged to capture images of the touch interface and determine whether the touch objects come in contact with the touch interface according to the captured images.

11. The touch-detecting method as claimed in claim 9, wherein the sensing device is a pressure sensing device arranged to detect the pressure of the touch interface and determine whether the touch objects comes in contact with the touch interface according to the pressure of the touch interface.

12. The touch-detecting method as claimed in claim 8, wherein the touch objects are implemented on different positions of a touch glove.

13. The touch-detecting method as claimed in claim 12, wherein the touch objects are arranged to be implemented on the positions of the thumb, forefinger and middle finger of the touch glove.

14. The touch-detecting method as claimed in claim 13, further comprising:
producing a determining signal according to the touch objects corresponding to the touch events; and
determining which finger corresponds to the touch events according to the determining signal.
